(19) United States
(12) Patent Application Publication
(10) Pub. No.: US 2023/0299258 A1
(43) Pub. Date: Sep. 21, 2023

(54) ELECTRODE MANUFACTURING METHOD AND ELECTRODE

(71) Applicant: TOYOTA JIDOSHA KABUSHIKI KAISHA, Toyota-shi (JP)

(72) Inventors: Tomoyuki UEZONO, Okazaki-shi (JP); Momoka ODA, Toyota-shi (JP); Yuuta ABE, Toyota-shi (JP)

(21) Appl. No.: 18/151,729

(22) Filed: Jan. 9, 2023

(30) Foreign Application Priority Data
Mar. 16, 2022 (JP) 2022-041355

(51) Int. Cl. H01M 4/04; H01M 4/36; H01M 4/62; B05D 1/06

(52) U.S. Cl. CPC H01M 4/0419; H01M 4/0404; H01M 4/366; H01M 4/623; B05D 1/06; H01M 2004/021

(57) ABSTRACT

An electric field is formed between a substrate and a screen by applying a first voltage to the substrate and applying a second voltage to the screen. Coating powder is introduced into the electric field through the screen. An electrode is manufactured by causing the coating powder to adhere to the substrate. The first voltage has a polarity opposite to a polarity of the second voltage. When the coating powder passes through the screen, the coating powder comes into contact with the screen to apply a charge to the coating powder. The coating powder flies in the electric field by an electrostatic force to reach the substrate. An angle between a flight direction of the coating powder and a vertically downward direction is 90 degrees to 270 degrees.

### CROSS-REFERENCE TO RELATED APPLICATION

This application claims priority to Japanese Patent Application No. 2022-041355 filed on Mar. 16, 2022, incorporated herein by reference in its entirety.

### BACKGROUND

### 1. Technical Field

The present disclosure relates to an electrode manufacturing method and an electrode.

### 2. Description of Related Art

Japanese Unexamined Patent Application Publication No. 2018-192380 (JP 2018-192380 A) discloses an electrostatic powder coating apparatus.

### SUMMARY

There is a proposal to manufacture an electrode by an electrostatic coating 20 technology. For example, an electric field is formed. A workpiece (substrate) is arranged at one end of the electric field. Coating powder is sprayed in the electric field. The coating powder contains active material particles. An electrostatic force acts on the coating powder. With the electrostatic force, the coating powder flies towards the substrate. With the electrostatic force, the coating powder adheres to the substrate. An active material layer may be formed as the coating powder adheres to the substrate.

For example, it is conceivable to adjust an angle between a flight direction of the coating powder in the electric field and a vertically downward direction to 90 degrees to 270 degrees. Thus, expression of a filter action is expected. The “filter action” is an action of removing metal foreign substances from the coating powder.

The coating powder may contain metal foreign substances. The metal foreign substances may be mixed, for example, during manufacture of the active material particles. The metal foreign substances may adversely affect battery performance. The flying coating powder is subjected to thrust and gravity. When the flight direction is, for example, a vertically upward direction, the thrust and the gravity may act in different directions. In general, the metal foreign substances are coarse particles. The metal foreign substances may have a larger mass than the active material particles. In addition, it is considered that the metal foreign substances are hardly charged because the metal foreign substances are conductors. Therefore, the gravity acting on the metal foreign substances may be greater than the thrust of flight (electrostatic force, wind pressure, etc.). Due to the greater effect of gravity, the metal foreign substances cannot fly or may fall even if they fly. Thus, it is expected that the metal foreign substances are removed from the coating powder.

However, the coating weight (adhesion amount per unit area) of the active material layer is limited in exchange for the filter action. The coating powder adheres to the substrate by the electrostatic force. That is, the adhesive force of the coating powder is proportional to the electrostatic force. As the coating weight increases (as the active material layer becomes thicker), the distance between the surface of the active material layer and the substrate (electrode) increases. The electrostatic force is inversely proportional to the square of the distance. Therefore, as the active material layer becomes thicker, the electrostatic force (adhesive force) acting on the surface of the active material layer decreases. For example, when the flight direction of the coating powder is the vertically upward direction, the gravity may act in a direction in which the coating powder separates from the substrate. When the thickness of the active material layer reaches a predetermined thickness, the gravity exceeds the adhesive force. When the gravity exceeds the adhesive force, new coating powder cannot adhere. That is, the coating weight of the active material layer reaches the upper limit value.

The present disclosure provides a technology for increasing the upper limit value of the coating weight of the active material layer.

Technical configurations and functions and effects of the present disclosure will be described below. An action mechanism according to the present specification includes estimation. The action mechanism does not limit the technical scope of the present disclosure.

1. A first aspect of the present disclosure relates to an electrode manufacturing method including:

forming an electric field between a substrate and a screen by applying a first voltage to the substrate and applying a second voltage to the screen;
introducing coating powder into the electric field through the screen; and manufacturing an electrode by causing the coating powder to adhere to the substrate.
The first voltage has a polarity opposite to a polarity of the second voltage. When the coating powder passes through the screen, the coating powder comes into contact with the screen to apply a charge to the coating powder. The coating powder flies in the electric field by an electrostatic force to reach the substrate. An angle between a flight direction of the coating powder and a vertically downward direction is 90 degrees to 270 degrees.

Since the angle between the flight direction of the coating powder and the vertically downward direction is 90 degrees to 270 degrees, expression of a filter action is expected.

In the related art, the substrate at one end of the electric field is grounded (0 V). That is, no voltage is applied to the substrate. In this case, the electrostatic force (adhesive force) acting on the coating powder adhering to the substrate is equal to an image force. When the coating powder deposits on the substrate, the thickness of the active material layer increases. As the thickness of the active material layer increases, the image force acting on the surface of the active material layer decreases. When the image force and the gravity are balanced on the surface of the active material layer, the coating weight of the active material layer reaches the upper limit value.

In the present disclosure, the first voltage is applied to the substrate. The first voltage applied to the substrate has the polarity opposite to the polarity of the second voltage applied to the screen. The charge is applied to the coating powder from the screen. Therefore, the substrate has a charge at the polarity opposite to that of the charge of the coating powder. When the substrate has the charge at the polarity opposite to that of the charge of the coating powder, an electrostatic force exceeding the image force can be generated. Thus, it is expected that the upper limit value of the coating weight of the active material layer increases.

It is also expected that the frequency of adhesion of the coating powder to the substrate increases through the increase in the adhesive force. Through the increase in the adhesion frequency, it is expected that the adhesion rate increases.

2. The flight direction of the coating powder may be, for example, a vertically upward direction.

This is because enhancement of the filter action is expected. The angle between the vertically upward direction and the vertically downward direction is 180 degrees.

3. The first voltage may have, for example, a positive polarity.

That is, the second voltage may have, for example, a negative polarity.

4. The coating powder may contain, for example, composite particles. Each of the composite particles may include an active material particle and a coating. The coating may cover at least a part of a surface of the active material particle. The coating may contain a binder.

In the related art, the active material layer is formed by applying a liquid coat. The liquid coat is referred to as, for example, “slurry” or “paste”. The liquid coat is prepared by dispersing the active material particles, the binder, and the like in a dispersion medium. When drying the liquid coat, the binder may move toward the surface of a coating film along with evaporation of the dispersion medium (liquid). This phenomenon is also referred to as “binder migration”. The binder migration may cause variations in the composition of the active material layer (distribution of the binder). The binder migration may cause inconveniences such as an increase in resistance and a decrease in peel strength.

In the composite particle of the present disclosure, the active material particle and the binder are bonded to each other in advance. The coating powder in the electrostatic coating technology may not require the dispersion medium. That is, there are few factors in the movement of the binder in the process of forming the active material layer. Therefore, it is expected that the distribution of the binder in the active material layer is made uniform.

5. The binder may contain, for example, a fluororesin.

The fluororesin is positioned on the most negative side in a charging sequence. When the binder contains the fluororesin, it is expected that the charging of the coating powder is promoted.

6. A relationship of the following expression (1) may be satisfied.

Ed<f(pd) (1)
where
“E” represents an electric field strength of the electric field,
“d” represents a distance between the substrate and the screen,
“p” represents a gas pressure in the electric field, and
“f(pd)” represents a spark voltage obtained based on a Paschen curve and a product of the gas pressure and the distance.

When the above expression (1) is satisfied, it is expected that spark discharge is reduced during the manufacture of the electrode.

7. The electrode may be manufactured in a batch system.

The electrode manufacturing system is roughly divided into a continuous system and the batch system. In the manufacturing method according to the item “1.”, the first voltage is applied to the substrate. For example, if the electrode is manufactured in the continuous system (roll-to-roll system), the substrate may have a length of several thousand meters. Since the first voltage is applied to a large part of manufacturing equipment, the manufacturing equipment may be complicated and expensive. In the manufacturing method according to the item “1.”, an electrode having a large coating weight can be manufactured. When the electrode having a large coating weight (thick electrode) is wound up around a roll, inconveniences such as cracking of the active material layer may also occur.

The manufacturing method according to the item “1.” is suitable for manufacturing sheet electrodes having large areas one by one in the batch system. The sheet electrodes having large areas can be used, for example, in stacked batteries having large areas. By adopting the batch system, it is expected that the manufacturing equipment is made compact.

8. A second aspect of the present disclosure relates to an electrode including a substrate and an active material layer. The substrate includes a first region and a second region. The first region is covered with the active material layer. The second region is exposed from the active material layer. The second region is adjacent to the first region. The active material layer includes a side end face. The side end face is in contact with a boundary between the first region and the second region. An angle between the side end face and the substrate is 45 degrees to 90 degrees.

The active material layer contains composite particles. Each of the composite particles includes an active material particle and a coating. The coating covers at least a part of a surface of the active material particle. The coating contains a binder.

A relationship of the following expression (2) is satisfied.

0.90≤α/β≤1.10 (2)
where
“α” represents a mass concentration of a specific element derived from the binder in an upper portion of the active material layer, and
“β” represents a mass concentration of the specific element in a lower portion of the active material layer.

The upper portion and the lower portion are segmented by dividing the active material layer into two equal parts in a thickness direction. The lower portion is located between the upper portion and the substrate.

In the present disclosure, the electrode having the structure according to the item “8.” can be manufactured.

For example, if the active material layer is formed by applying a liquid coat, liquid may run. That is, the end of the liquid coat runs outward in a coating film (active material layer before drying). As a result, the side end face of the active material layer is inclined. The angle (inclination angle) between the side end face of the active material layer and the substrate is less than 45 degrees.

In the present disclosure, the coating powder is used. In the present disclosure, there are few factors in the inclination of the side end face of the active material layer. Therefore, the inclination angle of 45 degrees to 90 degrees can be realized. As the inclination angle is closer to 90 degrees, a dead space between positive and negative electrodes in a battery can be reduced more. By reducing the dead space, it is expected that the energy density of the battery is improved.

In the present disclosure, the binder can be distributed uniformly. The distribution of the binder can be evaluated by a migration index. In the above expression (2), “α/β” represents the migration index. It is considered that the binder is distributed more uniformly as the migration index is closer to 1. For example, if the binder migration occurs while drying the liquid coat, the binder is unevenly distributed in the upper portion of the active material layer. At this time, the migration index may take a value of, for example, 2 to 3. In the present disclosure, the composite particles each obtained by bonding the active material particle and the binder in advance can be used. Further, there are few factors in the movement of the binder (for example, evaporation of the dispersion medium). Thus, a migration index of 0.9 to 1.1 can be realized.

9. The active material layer may have a coating weight of, for example, 20 mg/cm² or more.

In the present disclosure, the upper limit value of the coating weight is large. Thus, the coating weight of, for example, 20 mg/cm² or more can be realized.

10. The active material layer may have a thickness of, for example, 100 μm to 1000 μm.

In the present disclosure, the upper limit value of the thickness is large. Thus, the thickness of, for example, 100 μm to 1000 μm can be realized.

11. The active material layer may have a rectangular planar shape. A length of one side of the active material layer in plan view may be, for example, 500 mm or more.

In the present disclosure, a sheet electrode having a large area can be manufactured.

12. A density of metal foreign substances in the active material layer may be 1 piece/m² or less.

In the present disclosure, the metal foreign substances can be reduced by the filter action during the electrode manufacturing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of an electrode manufacturing method according to an embodiment;

FIG. 2 is a conceptual diagram showing the electrode manufacturing method according to the embodiment;

FIG. 3 is a conceptual diagram showing an electrode manufacturing method according to a reference embodiment;

FIG. 4 is a conceptual diagram of a composite particle according to the embodiment;

FIG. 5 is a schematic plan view showing an electrode according to the embodiment;

FIG. 6 is a schematic partial cross-sectional view showing the electrode according to the embodiment;

FIG. 7 is a schematic cross-sectional view showing an electrode manufacturing apparatus according to an example;

FIG. 8 is a graph showing a relationship between a coating time and a coating weight;

FIG. 9 shows scanning electron microscope (SEM) images showing results of a second experimental example;

FIG. 10 is a conceptual diagram showing a method for measuring a migration index;

FIG. 11 shows an example of a Paschen curve; and

FIG. 12 is a conceptual diagram showing an angle between a flight direction of coating powder and a vertically downward direction.

### DETAILED DESCRIPTION OF EMBODIMENTS

Hereinafter, an embodiment of the present disclosure (hereinafter sometimes simply referred to as “present embodiment”) and an example of the present disclosure (hereinafter sometimes simply referred to as “present example”) will be described. However, the embodiment and the example are not intended to limit the technical scope of the present disclosure.

### Definition of Terms, Etc

The terms “comprise”, “include”, “have”, and variations thereof (for example, “composed of”) are open-ended formats. The open-ended format may or may not include additional elements in addition to essential elements. The term “consist of” is a closed-ended format. Even the closed-ended format does not exclude normally-associated impurities and additional elements that are irrelevant to the technology according to the present disclosure. The term “substantially consist of” is a semi-closed-ended format. The semi-closed-ended format allows addition of elements that do not substantially affect the basic and novel characteristics of the technology according to the present disclosure.

Expressions such as “may” and “can” are used in the permissive sense of “having a possibility of” rather than in the obligatory sense of “must”.

Elements in a singular form can also be plural unless otherwise specified. For example, the term “particle” may mean not only “one particle” but also “agglomerate of particles (powder, powdery material, or group of particles).”

For multiple steps, actions, operations, and the like included in various methods, the execution order thereof is not limited to the described order unless otherwise specified. For example, the multiple steps may proceed concurrently. For example, the order of the multiple steps may be reversed.

For example, numerical ranges such as “m % to n %” include upper and lower limit values unless otherwise specified. That is, “m % to n %” indicates a numerical range of “m % or more and n % or less”. Further, “m % or more and n % or less” includes “more than m % and less than n %”. Further, a numerical value optionally selected from within a numerical range may be set as a new upper limit value or a new lower limit value. For example, a new numerical range may be set by optionally combining a numerical value in the numerical range and a numerical value described in a different part of the present specification, a table, the drawings, or the like.

All numerical values are modified by the term “approximately”. The term “approximately” may mean, for example, ±5%, ±3%, and ±1%. All numerical values may be approximate values that may vary depending on the manner in which the technology of the present disclosure is used. All numerical values may be expressed in significant figures. A measured value may be an average value of a plurality of measurements. The number of measurements may be three or more, five or more, or ten or more. It is generally expected that the reliability of the average value increases as the number of measurements increases. A measured value may be rounded off based on the number of significant figures. A measured value may include a deviation or the like due to, for example, a detection limit of a measuring device.

When a compound is represented by a stoichiometric composition formula (for example, “LiCoO₂”), the stoichiometric composition formula is merely a representative example of the compound. The compound may have a non-stoichiometric composition. For example, when lithium cobalt oxide is represented by “LiCoO₂”, lithium cobalt oxide is not limited to the composition ratio of “Li:Co:0=1:1:2” and may contain lithium (Li), cobalt (Co), and oxygen (O) at any composition ratio, unless otherwise specified. Moreover, doping with a trace element, substitution with a trace element, or the like may be permissible.

Geometric terms (for example, “parallel”, “perpendicular”, and “orthogonal”) are not to be taken in a strict sense. For example, “parallel” may deviate somewhat from “parallel” in a strict sense. Geometric terms as used in the present specification may include, for example, tolerances or variations in terms of design, work, or manufacturing. The dimensional relationships in the drawings may not match the actual dimensional relationships. The dimensional relationships (length, width, thickness, etc.) in the drawings may be changed to facilitate understanding of the technology of the present disclosure. Moreover, a part of the configurations may be omitted.

A “plan view” indicates viewing an object with a line of sight parallel to a thickness direction of the object.

FIG. 12 is a conceptual diagram showing an angle between a flight direction of coating powder and a vertically downward direction. The “angle (Θ)” is defined such that a counterclockwise direction from the vertically downward direction (vd) to the flight direction (fd) is a positive direction. When the angle (Θ) is 90 degrees or 270 degrees, the flight direction (fd) is a horizontal direction. When the angle (Θ) is 180 degrees, the flight direction (fd) is a vertically upward direction. For example, “90 degrees to 270 degrees” may be expressed as “90° to 270°”.

“D50” is defined as a particle size at which the cumulative frequency reaches 50% in a volume-based particle size distribution when counted from the smallest particle size. “D99” is defined as a particle size at which the cumulative frequency reaches 99% in the volume-based particle size distribution when counted from the smallest particle size. D50 and D99 can be measured by a laser diffraction particle size distribution measuring device.

Metal foreign substances (particles) have a “minor axis” and a “major axis”. The “major axis” refers to a distance between the farthest two points on the contour line of a particle image. The “minor axis” refers to a diameter orthogonal to a line segment of the major axis at the midpoint of the line segment. The minor axis may be equal to the major axis.

“Density of metal foreign substances” can be measured by the following procedure.

(1) An electrode is prepared. An active material layer is recovered from the electrode. A particle dispersion is prepared by dispersing the active material layer in a dispersion medium. The dispersion medium is selected, for example, depending on the type of a binder. For example, N-methyl-2-pyrrolidone (NMP) may be used.
(2) A bar magnet is immersed in the particle dispersion to collect magnetic matter contained in the particle dispersion. The metal foreign substances mixed in coating powder are usually magnetic matter.
(3) The bar magnet is removed from the particle dispersion. The magnetic matter attracted to the bar magnet is recovered. The magnetic matter may be recovered using, for example, an adhesive tape.
(4) For example, the composition of the magnetic matter is identified by X-Ray fluorescence (XRF). Whether the magnetic matter is the metal foreign substances is determined based on the composition of the magnetic matter. The metal foreign substances are counted.
(5) The density (pieces/m²) is obtained by dividing the number of the metal foreign substances by the area of the active material layer.

The term “melting point” indicates a peaktop temperature of a melting peak (endothermic peak) in a differential scanning calorimetry (DSC) curve. The DSC curve can be measured conforming to “JIS K 7121”. The term “near melting point” may indicate a range of, for example, ±20° C. around the melting point.

The term “electrode” is a general term for positive and negative electrodes. The electrode may be a positive electrode or a negative electrode. The electrode may be, for example, used for a lithium ion battery. The lithium ion battery may be, for example, a liquid battery or an all-solid-state battery. The electrode may be applied to any electrochemical device. In the present embodiment, description will be given of an example in which electrodes are applied to a lithium ion battery.

The term “positive voltage” indicates a voltage having a positive polarity (+). The term “positive charge” indicates a charge having a positive polarity. The term “negative voltage” indicates a voltage having a negative polarity (—). The term “negative charge” indicates a charge having a negative polarity. The positive and negative polarities are opposite to each other.

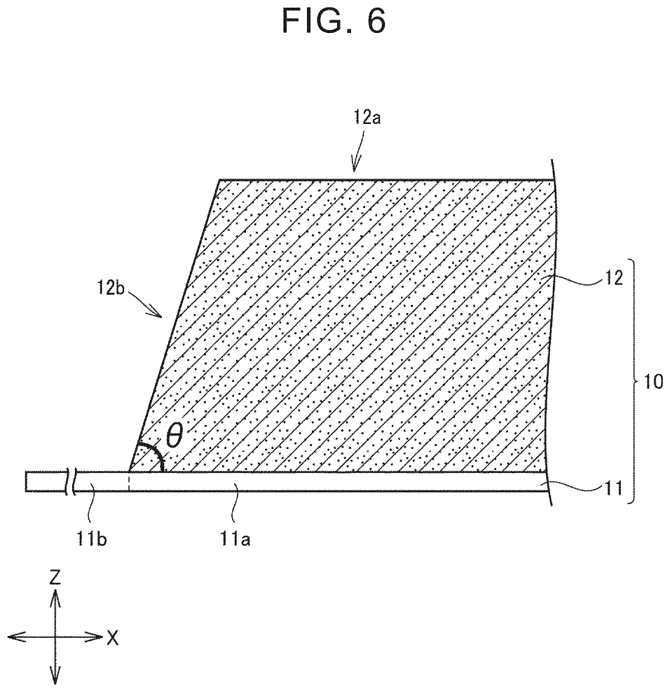

The term “inclination angle of side end face” indicates an acute angle among the angles between a side end face and a substrate (see “0” in FIG. 6). The inclination angle (Θ) is measured in a cross-sectional image of an electrode 10. The cross-sectional image is captured at a portion where a substrate 11 extends on an outer side of a side end face 12b. The cross-sectional image may be captured, for example, by an optical microscope (OM) or a scanning electron microscope (SEM). For example, an appropriate observation device is selected depending on the thickness of an active material layer 12. The side end face 12b may be curved. The cross-sectional image shows a line segment connecting the leading end of the side end face 12b and the trailing end of the side end face 12b. The leading end is a contact point between the side end face 12b and the substrate 11. The trailing end is a boundary between the side end face 12b and a principal surface 12a of the active material layer 12. The angle (Θ) between the line segment and the principal surface of the substrate 11 is measured. The “principal surface” indicates a surface having the largest area among the outer surfaces of an object (typically a hexahedron).

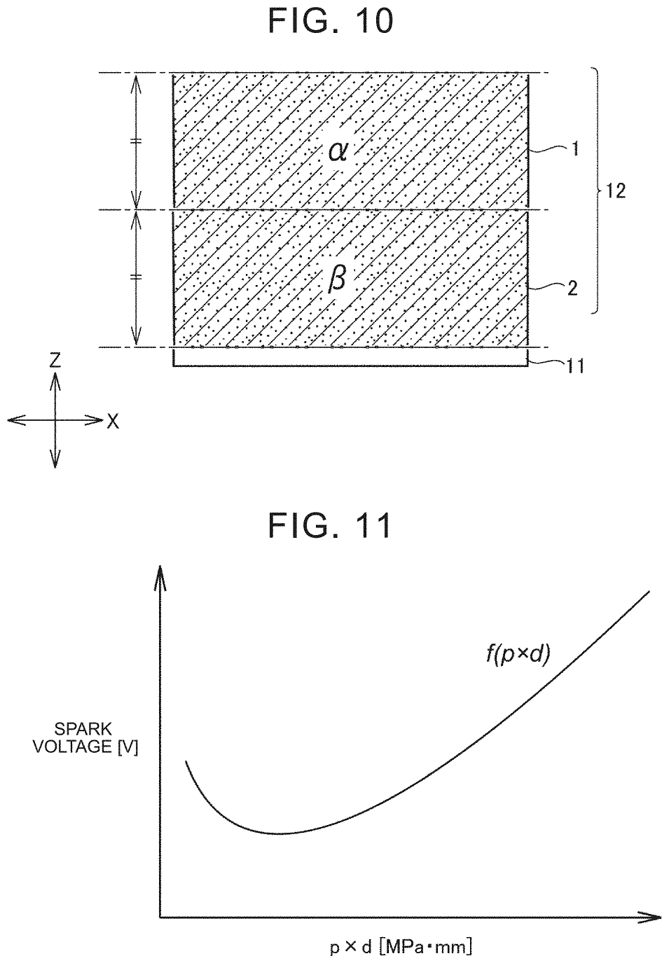

A “migration index” is measured in the following procedure. A sample is cut out from the electrode. The cut surface is parallel to a thickness direction of the active material layer. A cross-sectional sample is prepared by performing cross-sectional processing on the cut surface of the active material layer. For example, the cross-sectional processing may be performed by an ion milling apparatus. The cross-sectional sample is analyzed by an electron probe micro analyzer (EPMA). FIG. 10 is a conceptual diagram showing a method for measuring the migration index. In the cross-sectional sample, the active material layer 12 is divided into two equal parts in the thickness direction, thereby segmenting the active material layer 12 into an upper portion (first layer) 1 and a lower portion (second layer) 2. The lower portion 2 is located between the upper portion 1 and the substrate 11. A specific element is selected depending on the type of the binder. The specific element is an element that can serve as a marker of the binder. For example, if the binder contains polyvinylidene difluoride (PVdF), fluorine may be the specific element. If the binder has no appropriate element, the specific element may be imparted to the binder by subjecting the cross-sectional sample to known staining treatment. The EPMA measures a mass concentration (α) of the specific element in the upper portion 1 and a mass concentration (β) of the specific element in the lower portion 2. By dividing α by β, a migration index (α/β) is obtained.

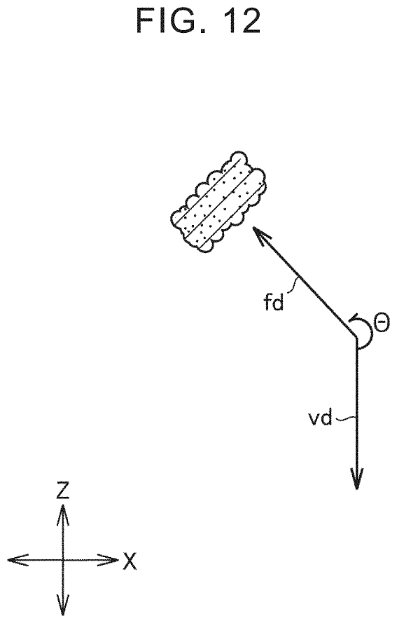

The “Paschen curve” represents a relationship between a spark voltage and the product (p×d) of a gas pressure (p) and a distance between electrodes (d). The product (p×d) is also expressed as “pd”. FIG. 11 shows an example of the Paschen curve. The graph of FIG. 11 is a double logarithmic graph. The Paschen curve may have a local minimum. FIG. 11 shows a Paschen curve for air as an example. The Paschen curve may vary depending on the type of gas. Known Paschen curves are available for any types of gas.

“Aerosol” indicates a dispersion system in which at least one of a solid and a liquid is dispersed in a gas. The aerosol may also be referred to as, for example, “fume” or “cloud powder”. The appearance of the aerosol may be described as, for example, “cloud-shaped” or “plume-shaped”.

Electrode Manufacturing Method

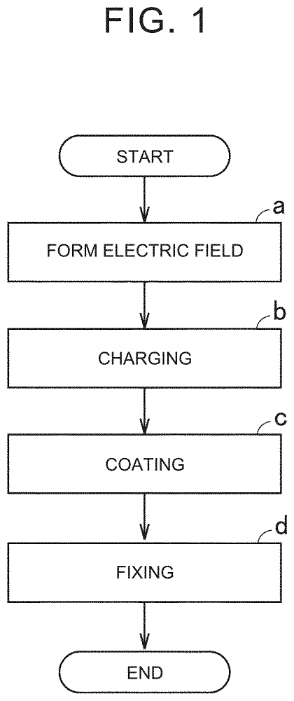

FIG. 1 is a schematic flowchart of an electrode manufacturing method according to the present embodiment. Hereinafter, the phrase “electrode manufacturing method according to the present embodiment” may be abbreviated to “present manufacturing method”. The present manufacturing method includes “(a) electric field formation”, “(b) charging”, and “(c) coating”. The present manufacturing method may further include, for example, “(d) fixing”.

(a) Electric Field Formation

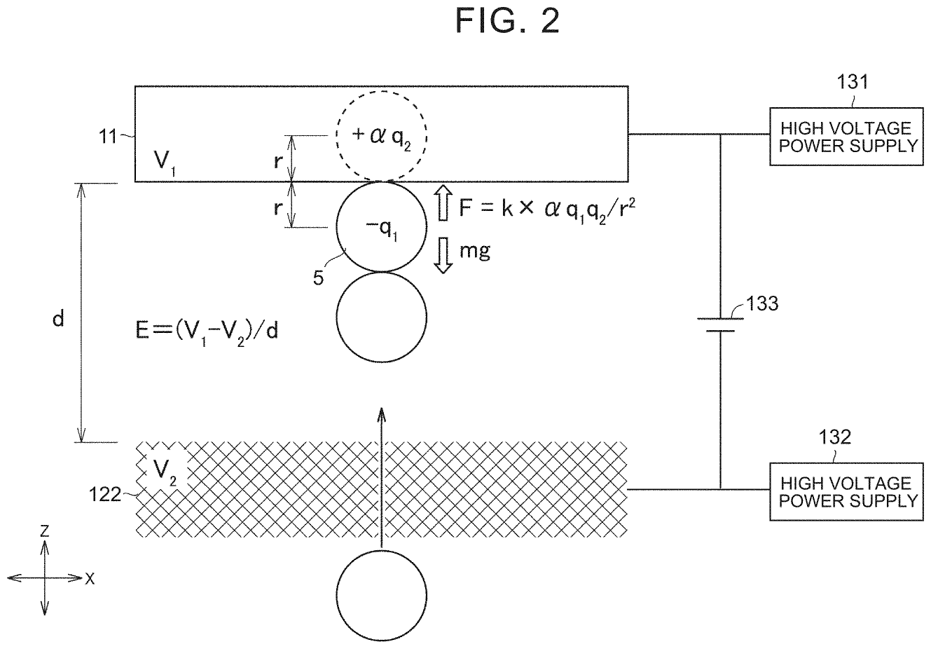

FIG. 2 is a conceptual diagram showing the electrode manufacturing method according to the present embodiment. The present manufacturing method includes forming an electric field by applying a first voltage (V₁) to the substrate 11 and applying a second voltage (V₂) to a screen.

The substrate 11 has electric conductivity. The substrate 11 may have, for example, a sheet shape. The substrate 11 may be, for example, a current collector. The substrate 11 may include, for example, metal foil. The substrate 11 may be referred to as, for example, “current collecting foil”. The substrate 11 may contain, for example, at least one selected from the group consisting of aluminum (Al), copper (Cu), nickel (Ni), chromium (Cr), titanium (Ti), and iron (Fe). The substrate 11 may include, for example, Al foil, Al alloy foil, or Cu foil. The substrate 11 may have a thickness of, for example, 5 μm to 50 μm.

A screen 122 is porous. The screen 122 may have through holes. The screen 122 has electric conductivity. For example, a screen in electrostatic screen printing may be used. The screen 122 may be, for example, a metal mesh. The screen 122 may be, for example, a stainless steel mesh. For example, the opening of the screen 122 may be adjusted so that the coating powder passes through the screen 122 and the frequency of contact between the coating powder and the screen 122 is moderate. The opening of the screen 122 may be, for example, 30 μm to 300 μm or 50 μm to 200 μm.

The substrate 11 and the screen 122 are connected to a direct current power supply 133. A first high voltage power supply 131 is connected to the substrate 11. The first high voltage power supply 131 applies the first voltage (V₁) to the substrate 11. A second high voltage power supply 132 is connected to the screen 122. The second high voltage power supply 132 applies the second voltage (V₂) to the screen 122.

The first voltage (V₁) has a polarity opposite to that of the second voltage (V₂). Therefore, it is expected that an upper limit value of a coating weight increases. For example, the first voltage (V₁) may be a positive voltage, and the second voltage (V₂) may be a negative voltage. For example, the first voltage (V₁) may be a negative voltage, and the second voltage (V₂) may be a positive voltage.

An electric field strength (E) is obtained by dividing a difference between the first voltage and the second voltage (V₁−V₂) by a distance (d) between the substrate 11 and the screen 122. The electric field strength (E) may be, for example, less than the spark voltage. The spark voltage is obtained based on the Paschen curve and the product of the gas pressure (p) and the distance (d). That is, the relationship of Expression (1) may be satisfied. The gas in the electric field may be, for example, air or an inert gas such as nitrogen or argon. The gas pressure (p) may be, for example, an atmospheric pressure. The gas pressure (p) may be, for example, 0.01 MPa to 1 MPa.

The electric field strength (E) may be, for example, 500 V/mm or less. The electric field strength may be, for example, 100 V/mm to 500 V/mm. The first voltage (V₁) may be, for example, +500 V to +1500 V. The second voltage (V₂) may be, for example, −3500 V to −2500 V. The distance (d) may be, for example, 1 mm to 20 mm or 5 mm to 10 mm.

The flight direction of the coating powder is adjusted based on the positional relationship between the substrate 11 and the screen 122. The direction from the screen 122 to the substrate 11 is the flight direction of the coating powder. The angle between the flight direction and the vertically downward direction is 90 degrees to 270 degrees. For example, when the flight direction is decomposed into a component in the vertical direction (Z axis direction in FIG. 2) and a component in the horizontal direction (X axis direction in FIG. 2), the flight direction may include a component in a vertically upward direction. When the flight direction includes the component in the vertically upward direction, it is expected that the filter action is enhanced. The flight direction may be, for example, the horizontal direction. The flight direction may be, for example, the vertically upward direction. The angle between the flight direction and the vertically downward direction may be, for example, 120 degrees to 240 degrees or 150 degrees to 210 degrees.

(b) Charging

The present manufacturing method includes introducing the coating powder into the electric field through the screen 122. The coating powder will be described later. For example, the coating powder (particles 5) may be transported to the screen by a gas flow. The gas may be, for example, air or an inert gas. For example, an aerosol may be formed by mixing the coating powder and the gas. The aerosol may be introduced into the electric field.

When the coating powder (particles 5) passes through the screen 122, the coating powder comes into contact with the screen 122. Thus, a charge is injected into the coating powder. The polarity of the charge is identical to the polarity of the second voltage (V₂). For example, when the second voltage (V₂) is a negative voltage, a negative charge is injected into the coating powder.

The particles 5 that have passed through the screen 122 are introduced into the electric field. An electrostatic force acts on the particles 5 introduced into the electric field. The particles 5 fly by the electrostatic force. The flight of the particles 5 may be assisted by, for example, wind pressure in addition to the electrostatic force. For example, a gas flow from a blower device may be used in combination.

(c) Coating

The present manufacturing method includes manufacturing an electrode 10 by causing the coating powder to adhere to the substrate 11. When the particles 5 fly through the electric field, the particles 5 reach the substrate 11. The particles 5 adhere to the substrate 11. When the particles 5 deposit on the substrate, an active material layer 12 is formed.

An electrostatic force (F) acts on the particles 5 adhering to the substrate 11. The electrostatic force (F) is represented by Expression (3).

F=k×q₁q₂/r² (3)

The symbol “F” represents the electrostatic force.
The symbol “k” represents a proportionality constant.
The symbol “q₁” represents an amount of electricity applied to the coating powder.
The symbol “q₂” represents an amount of electricity applied to the substrate 11.
The symbol “r” represents a distance between the substrate 11 and the coating powder.

When the first voltage is not applied to the substrate 11 and the substrate 11 is grounded (0 V), a relationship of “q₁=q₂” is satisfied in Expression (3). When the relationship of “q₁=q₂” is satisfied, the electrostatic force is equal to an image force.

The gravity (mg) also acts on the particles 5 adhering to the substrate 11. The symbol “m” represents a mass of the particles 5, and the symbol “g” represents a gravitational acceleration. The gravity (mg) acts in a direction in which the particles 5 separate from the substrate 11.

In the present manufacturing method, the first voltage (V₁) is applied to the substrate 11. Therefore, the amount of electricity of the substrate 11 increases. When the first voltage (V₁) is applied to the substrate 11, the amount of electricity of the substrate 11 is expressed by “α×q₁” (α>1). Thus, an electrostatic force of “F=k×αq₁ q₂/r²” acts on the particles 5. Accordingly, it is expected that the adhesive force of the coating powder is improved. Through the improvement in the adhesive force, it is expected that the upper limit value of the coating weight increases. It is also expected that the frequency of adhesion of the coating powder to the substrate 11 increases. Through the increase in the adhesion frequency, it is expected that the adhesion rate increases.

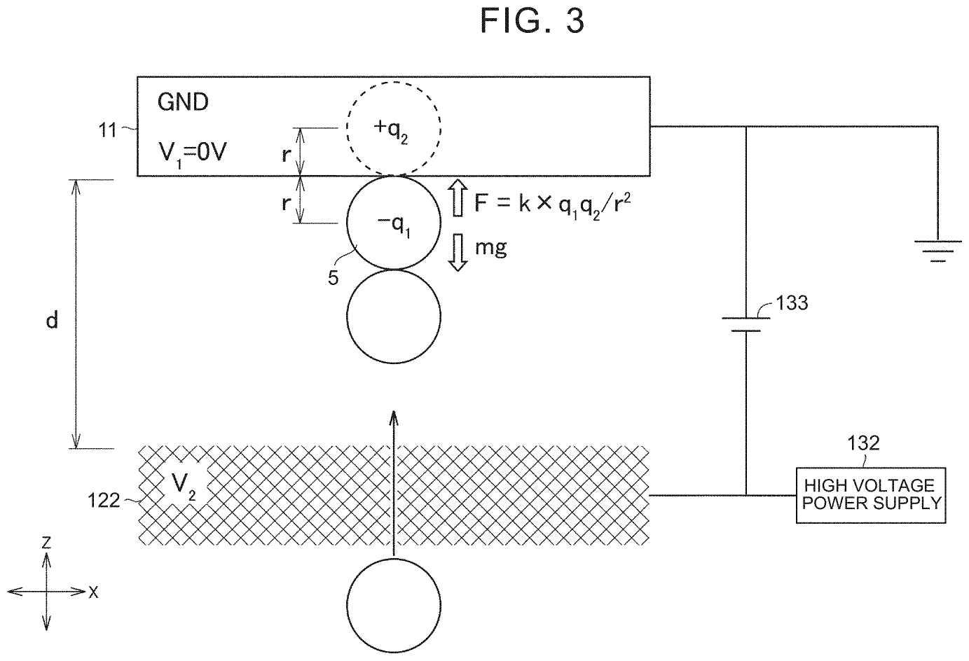

FIG. 3 is a conceptual diagram showing an electrode manufacturing method according to a reference embodiment. In FIG. 3, the high voltage power supply is not connected to the substrate 11. That is, the first voltage (V₁) is not applied to the substrate 11. The substrate 11 is grounded (GND=0 V). The second voltage (V₂) is applied to the screen 122. In the reference embodiment, the electrostatic force acting on the particles 5 is equal to the image force. That is, the electrostatic force acting on the particles 5 is “F=k×q₁q₂/r²”. The electrostatic force in the reference embodiment is “1/α” of the electrostatic force in the present manufacturing method. That is, the electrostatic force in the reference embodiment is smaller than the electrostatic force in the present manufacturing method. Therefore, the upper limit value of the coating weight in the reference embodiment may be smaller than that in the present manufacturing method. In the reference embodiment, the adhesion rate may be lower than that in the present manufacturing method.

(d) Fixing

The present manufacturing method may include fixing the active material layer 12 to the substrate 11 by applying at least one of pressure and heat to the active material layer 12. It is expected that the peel strength of the active material layer 12 is improved by fixing the active material layer 12.

The pressure and the heat may be applied separately. The pressure and the heat may be applied substantially simultaneously. For example, the active material layer 12 may be compressed by a heat roll or a heat plate. The heating temperature of the active material layer 12 may be, for example, a temperature near the melting point of the binder. The heating temperature may be, for example, 80° C. to 200° C. The pressure may be adjusted, for example, depending on a target thickness or a target density of the active material layer 12. For example, a pressure of 50 MPa to 200 MPa may be applied to the active material layer 12.

In the manner described above, the electrode 10 can be manufactured. The electrode 10 may be manufactured, for example, in a continuous system. The electrode 10 may be manufactured, for example, in a batch system.

Coating Powder

A liquid coat has a composition different from that of the active material layer 12. This is because the liquid coat contains a dispersion medium (liquid). The coating powder may have the same composition as that of the active material layer 12. The coating powder contains active material particles. The coating powder may further contain, for example, a binder, an electrically conductive material, or a solid electrolyte in addition to the active material particles.

The active material particles may have a D50 of, for example, 1 μm to 30 μm, 1 μm to 20 μm, or 1 μm to 10 μm. The active material particles may have a D99 of, for example, 30 μm to 50 μm.

The active material particles cause electrode reactions. The active material particles may contain any component. The active material particles may contain, for example, a positive electrode active material. The active material particles may contain, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the whole of the elements inside the parentheses is 1 in terms of the composition ratio. The individual components of “(NiCoMn)” can be contained at any composition ratio as long as the whole is 1. Li(NiCoMn)O₂ may include, for example, Li(Ni_{1/3}Co_{1/3}Mn_{1/3})O₂, Li(Ni_{0.5}Co_{0.2}Mn_{0.3})O₂, and Li(Ni_{0.8}Co_{0.1}Mn_{0.1})O₂.

The active material particles may contain, for example, a negative electrode active material. The active material particles may contain, for example, at least one selected from the group consisting of graphite, soft carbon, hard carbon, silicon, silicon oxide, silicon-based alloys, tin, tin oxide, tin-based alloys, and Li₄Ti₅O₁₂.

The binder may be powdery. The binder bonds solid materials to each other in the active material layer 12. For example, 0.1 parts by mass to 10 parts by mass of the binder may be added per 100 parts by mass of the active material particles. The binder may contain any component. The binder may contain, for example, at least one selected from the group consisting of PVdF, polytetrafluoroethylene (PTFE), a polyvinylidene difluoride-hexafluoropropylene copolymer (PVdF-HFP), styrene butadiene rubber (SBR), carboxymethyl cellulose (CMC), polyimide (PI), polyamideimide (PAI), and polyacrylic acid (PAA).

The binder may contain, for example, a fluororesin. The fluororesin may include, for example, at least one selected from the group consisting of PVdF, PVdF-HFP, and PTFE. When the binder contains the fluororesin, the charging of the coating powder can be promoted. This is because the fluororesin is positioned on the most negative side in a charging sequence.

The electrically conductive material may be powdery. The electrically conductive material can form an electron conduction path in the active material layer 12. For example, 0.1 parts by mass to 10 parts by mass of the electrically conductive material may be added per 100 parts by mass of the active material particles. The electrically conductive material may contain any component. The electrically conductive material may contain, for example, electrically conductive carbon particles and electrically conductive carbon fibers. The electrically conductive material may contain, for example, at least one selected from the group consisting of carbon black, vapor-grown carbon fibers, carbon nanotubes, and graphene flakes. The carbon black may contain, for example, at least one selected from the group consisting of acetylene black, furnace black, channel black, and thermal black.

The solid electrolyte may be powdery. The solid electrolyte can form an ion conduction path in the active material layer 12. For example, 10 parts by volume to 100 parts by volume of the solid electrolyte may be added per 100 parts by volume of the active material particles. The solid electrolyte may contain any component. The solid electrolyte may contain, for example, at least one selected from the group consisting of Li₂S—P₂S₅, LiI—Li₂S—P₂S₅, LiBr—Li₂S—P₂S₅, and LiI—LiBr—Li₂S—P₂S₅.

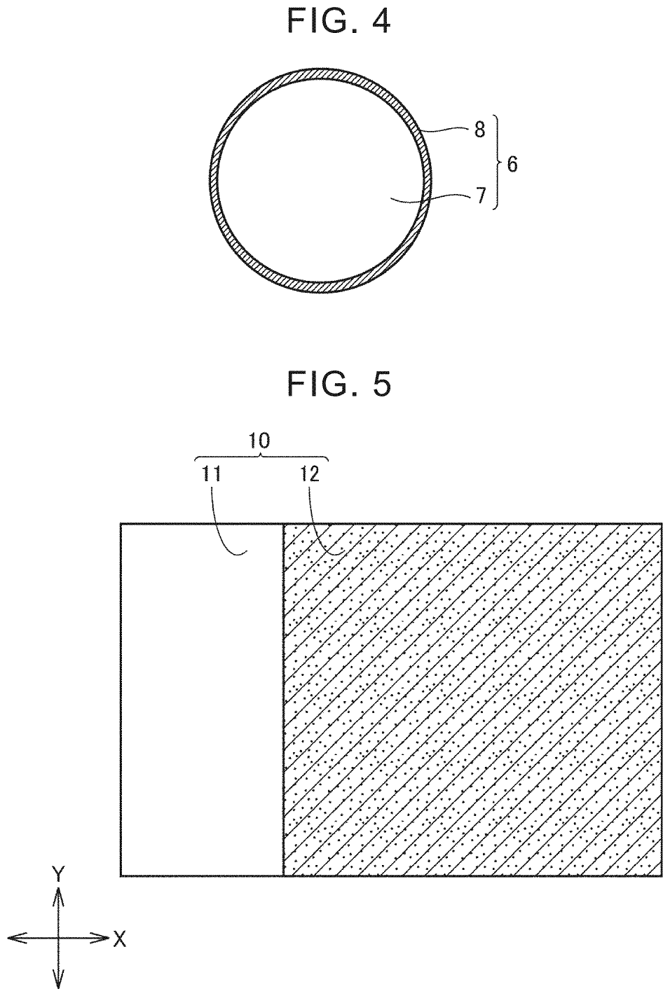

FIG. 4 is a conceptual diagram of a composite particle according to the present embodiment. The coating powder may contain composite particles 6. Each composite particle 6 can be formed as a composite of an active material particle 7 and any other material. The composite particle 6 includes the active material particle 7 and a coating 8. The active material particle 7 is the core of the composite particle 6. The coating 8 is a shell of the composite particle 6. The coating 8 covers at least a part of the surface of the active material particle 7. The coating 8 contains a binder. The coating 8 may further contain an electrically conductive material, a solid electrolyte, or the like.

The composite particle 6 can be formed by any method. For example, the composite particle 6 may be formed by mixing the active material particle 7 and the other material under the condition that a strong shear force is applied. In the present manufacturing method, any particle composite apparatus can be used. After the formation of the composite particle 6, for example, the composite particle 6 may be subjected to heat treatment at a temperature near the melting point of the binder. By the heat treatment, the binder is softened, melted, and resolidified. As a result, it is expected that the coating 8 is firmly fixed to the surface of the active material particle 7. If the fixing strength is low, the coating 8 may peel off from the surface of the active material particle 7, for example, during the flight of the composite particle 6.

Electrode

FIG. 5 is a schematic plan view showing the electrode according to the present embodiment. The electrode 10 includes the substrate 11 and the active material layer 12. The active material layer 12 is disposed on a part of the principal surface of the substrate 11. The active material layer 12 may be formed on only one side of the substrate 11 or on both front and back sides thereof.

The active material layer 12 may have any planar shape. The active material layer 12 may have, for example, a rectangular planar shape. The active material layer 12 may have a large area. In plan view, the length of one side of the active material layer 12 may be, for example, 500 mm or more, 1000 mm or more, or 1500 mm or more. In plan view, the length of one side of the active material layer 12 may be, for example, 3000 mm or less.

The active material layer 12 may have a large coating weight. The active material layer 12 may have, for example, a coating weight of 20 mg/cm² or more, 40 mg/cm² or more, or 60 mg/cm² or more. The active material layer 12 may have, for example, a coating weight of 120 mg/cm² or less or 100 mg/cm² or less.

FIG. 6 is a schematic partial cross-sectional view showing the electrode according to the present embodiment. The substrate 11 includes a first region 11a and a second region 11b. FIG. 6 shows the vicinity of a boundary between the first region 11a and the second region 11b. The first region 11a is covered with the active material layer 12. The second region 11b is adjacent to the first region 11a. The second region 11b is exposed from the active material layer 12. The second region 11b extends outward from the active material layer 12. The second region 11b may be referred to as, for example, “uncoated portion” or “non-coated portion”. In the second region 11b, a current collecting member can be joined. The current collecting member can be joined, for example, by ultrasonic bonding, spot welding, or laser welding. The current collecting member may include, for example, a current collecting plate, a lead tab, and an electrode terminal.

The active material layer 12 includes the principal surface 12a and the side end face 12b. The side end face 12b is connected to the principal surface 12a. The side end face 12b is in contact with the boundary between the first region 11a and the second region 11b. The angle (Θ) between the side end face 12b and the principal surface of the substrate 11 is 45 degrees to 90 degrees. As the angle (Θ) is closer to 90 degrees, a higher energy density is expected. The angle (Θ) may be, for example, 60 degrees to 90 degrees, 70 degrees to 90 degrees, or 80 degrees to 90 degrees.

The active material layer 12 may have a thickness of, for example, 100 μm to 1000 μm or 200 μm to 500 μm.

The active material layer 12 contains the composite particles 6. Since the agglomerate of the composite particles 6 forms the active material layer 12, the distribution of the binder can be uniform. The active material layer 12 has a migration index of 0.9 to 1.10. That is, the relationship of Expression (2) is satisfied. The active material layer 12 may have, for example, a migration index of 0.92 or more or 0.94 or more. The active material layer 12 may have, for example, a migration index of 1.08 or less or 1.06 or less.

The active material layer 12 may have a low density of metal foreign substances. The density of the metal foreign substances may be, for example, 1 piece/m² or less or 0.5 pieces/m² or less. The density of the metal foreign substances may be zero. The metal foreign substances may be, for example, magnetic substances. The metal foreign substances may contain, for example, a component derived from stainless steel (SUS), iron (Fe), or iron oxide. The metal foreign substances may be coarse particles. The minor axis of the metal foreign substance may be, for example, larger than the D99 of the active material particle. The minor axis of the metal foreign substance may be, for example, two to 10 times, two to five times, or two to three times the D99 of the active material particle.

### First Experimental Example

In a first experimental example, the polarity of the first voltage was examined.

### First Manufacturing Example

The following materials were prepared.
Active material particle: Li(NiCoMn)O₂
Electrically conductive material: acetylene black

### Binder: PVdF

A mixing apparatus “Multi-Purpose Mixer” manufactured by Nippon Coke & Engineering. Co., Ltd. was prepared. This apparatus includes a spherical tank (mixing tank). With a convection promoting effect of the spherical tank, a strong shear force can be generated and solid materials can be composited.

The active material particles, the electrically conductive material, and the binder were charged into the spherical tank. The blending ratio of the materials was “active material particles:electrically conductive material:binder=90:5:5 (mass ratio)”. The rotation speed of stirring blades was set to 10000 rpm. The materials were mixed for 10 minutes. Thus, composite particles were formed. Each composite particle included the active material particle and a coating. The coating covered the surface of the active material particle. The coating contained the binder and the electrically conductive material.

A metal tray was prepared. An agglomerate (powder) of the composite particles was thinly spread on the tray. The tray was stored in an oven, and the composite particles were subjected to heat treatment. The temperature of the oven was set to 160° C. The storage time was 30 minutes. It is considered that the coating was fixed to the surface of the active material particles by the heat treatment. In the manner described above, coating powder containing the composite particles was prepared.

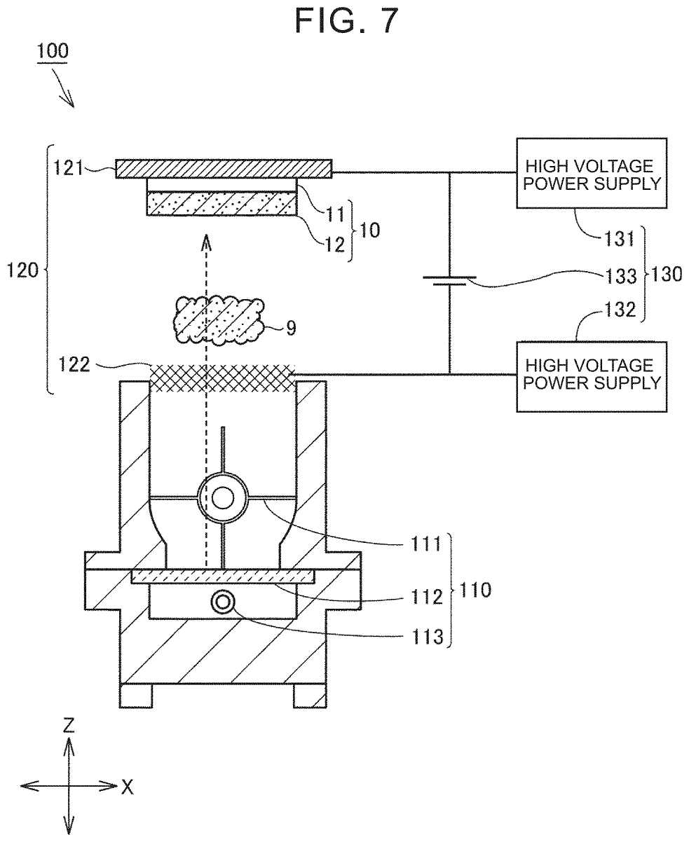

FIG. 7 is a schematic cross-sectional view showing an electrode manufacturing apparatus according to the present example. An electrode manufacturing apparatus 100 includes an introduction unit 110, a developing unit 120, and an electric field forming unit 130.

The introduction unit 110 includes stirring blades 111, a perforated plate 112, and a fan 113. The perforated plate 112 is an alumina perforated plate (opening: 10 μm, plane size: 75 mm×75 mm).

The developing unit 120 includes a developing electrode 121 and the screen 122. The screen 122 is a SUS mesh (opening: 100 μm). A gap between the developing electrode 121 and the screen 122 is 8 mm.

The electric field forming unit 130 includes the first high voltage power supply 131, the second high voltage power supply 132, and the direct current power supply 133. The first high voltage power supply 131 applies a positive voltage to the developing electrode 121. The second high voltage power supply 132 applies a negative voltage to the screen 122.

The substrate 11 was disposed on the surface of the developing electrode 121. The substrate 11 was Al foil (thickness: 12 μm). The substrate 11 has a potential equal to that of the developing electrode 121. The coating powder was supplied onto the perforated plate 112. The fan 113 supplied a gas flow to the coating powder to raise the coating powder. The type of the gas was air. The flow rate of the gas was 25 L/min. An aerosol 9 was formed when the stirring blades 111 mixed the coating powder and the gas. The rotation speed of the stirring blades 111 was 120 rpm. The aerosol 9 passed through the screen 122. The charged aerosol 9 was introduced into the electric field. When the aerosol 9 came into contact with the surface of the substrate 11, the coating powder adhered to the substrate 11. Thus, the active material layer 12 was formed. The plane size of the active material layer 12 was 60 mm×200 mm.

After the formation of the active material layer 12, the electrode 10 was sandwiched between two heat plates (flat plates). The temperature of the heat plates was 160° C. A load of 15 tf was applied to the active material layer 12 by the heat plates. Thus, the active material layer 12 was fixed to the substrate 11. In the manner described above, the electrode 10 was manufactured.

### Second Manufacturing Example

The manufacture of the electrode 10 was attempted in the same manner as in the first manufacturing example except that the first voltage (V₁) and the second voltage (V₂) were changed as shown in Table 1.

### Third Manufacturing Example

The manufacture of the electrode 10 was attempted in the same manner as in the first manufacturing example except that the first voltage (V₁) and the second voltage (V₂) were changed as shown in Table 1.

### Table 1

TABLE 1

| | Substrate | Screen | | Coating weight | |
|---|---|---|---|---|---|
| | First | Second | Electric | | Upper |
| | voltage | voltage | field | 50 seconds | limit |
| | (V₁) | (V₂) | strength | later | value |
| | [V] | [V] | [V/mm] | mg/cm² | mg/cm² |
| First | 0 | −4000 | 500 | 41 | 79 |
| manufacturing | | | | | |
| example | | | | | |
| Second | −1000 | −5000 | 500 | 0 | 0 |
| manufacturing | | | | | |
| example | | | | | |
| Third | +1000 | −3000 | 500 | 61 | 105 |
| manufacturing | | | | | |
| example | | | | | |

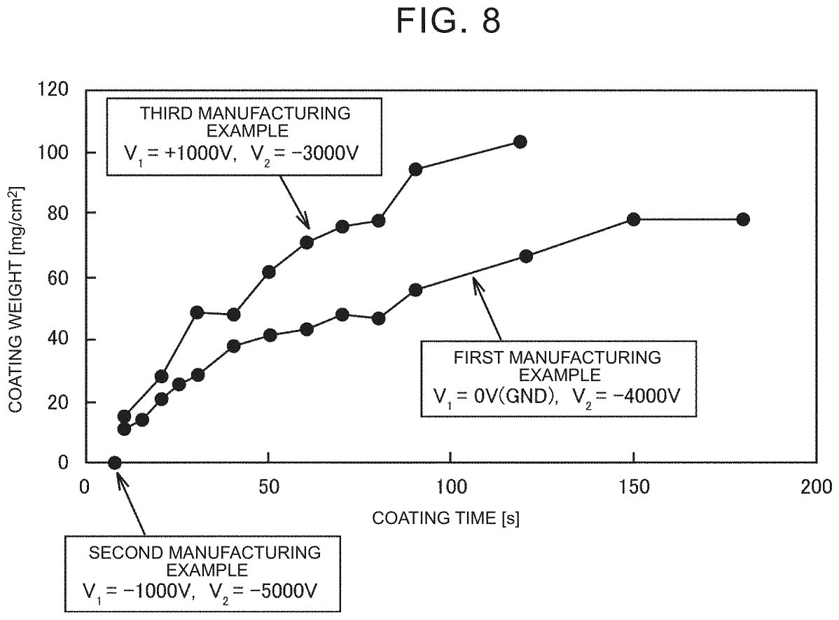

FIG. 8 is a graph showing a relationship between a coating time and the coating weight. In all of the first to third manufacturing examples, the electric field strength is 500 V/mm. In the second manufacturing example, the coating powder did not adhere to the substrate. In the second manufacturing example, the first voltage (V₁) has the same polarity as that of the second voltage (V₂). A negative charge is injected into the coating powder at the screen. The substrate also has a negative charge. It is considered that electrostatic repulsion forces the coating powder away from the substrate.

In the first manufacturing example and the third manufacturing example, an active material layer having no drawbacks was formed. The coating weight increases along with an increase in the coating time, and is eventually saturated. That is, the coating weight reaches the upper limit value. In the third manufacturing example, the upper limit value of the coating weight was larger than that in the first manufacturing example. In FIG. 8, it is considered that the adhesion rate increases as the slope of the curve is greater. The third manufacturing example exhibits a higher adhesion rate than the first manufacturing example. The coating weight after the elapse of 50 seconds also indicates the degree of the adhesion rate (see Table 1).

In the first manufacturing example, the first voltage (V₁) is 0 V (GND). In the third manufacturing example, the first voltage (V₁) has a polarity opposite to that of the second voltage (V₂). It is considered that the coating powder having the negative charge is attracted to the substrate having the positive charge to promote the adhesion of the coating powder.

### Second Experimental Example

In a second experimental example, the filter action was examined.

As the metal foreign substances, SUS particles were prepared. The SUS particles each had a minor axis of 45 μm to 90 μm. The coating powder (composite particles) prepared in the first experimental example was mixed with 10% of SUS particles in mass fraction. The SUS particles each had a minor axis larger than the D99 of the active material particle.

Except that the coating powder containing the metal foreign substances was used, the manufacture of the electrode was attempted under the same conditions as those in the third manufacturing example of the first experimental example. At the stages of the initial coating powder (before flight), the aerosol (during flight), and the active material layer (after adhesion), predetermined amounts of powder samples were collected. The powder samples were observed by the SEM.

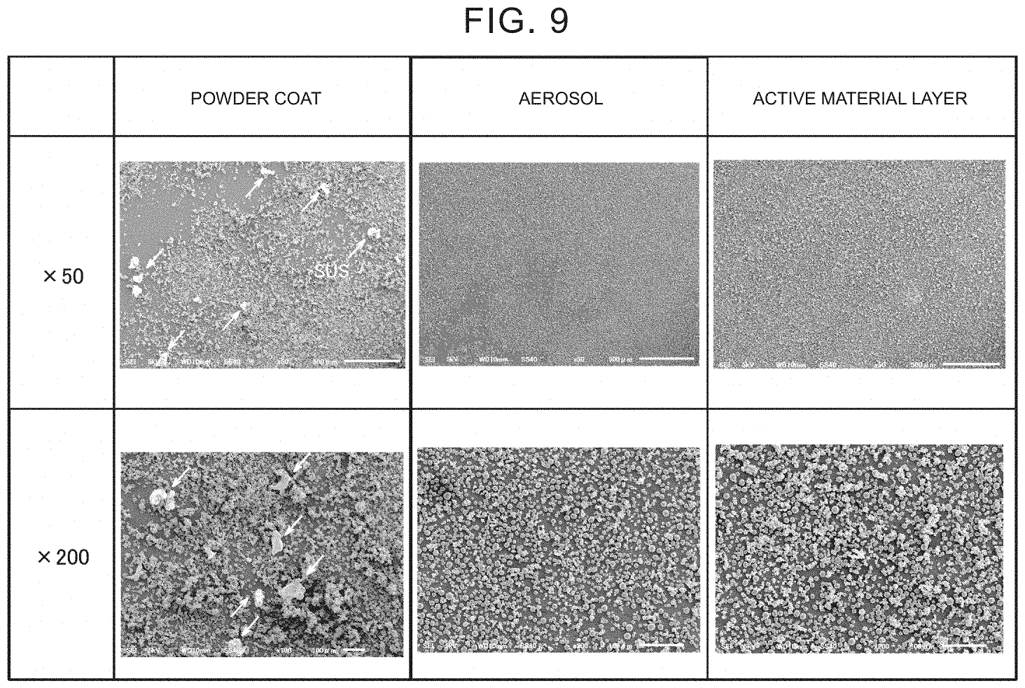

FIG. 9 shows SEM images showing results of the second experimental example. In the initial coating powder, the presence of metal foreign substances (SUS particles) can be observed. In the aerosol and the active material layer, the metal foreign substances cannot be observed. It is considered that the metal foreign substances are removed by the filter action of the present manufacturing method.

The present embodiment and the present example are illustrative in all respects. The present embodiment and the present example are not restrictive. The technical scope of the present disclosure includes all modifications that fall within the meaning and scope equivalent to the claims. For example, it is planned from the beginning to extract desired configurations from the present embodiment and the present example and combine the extracted configurations as desired.

What is claimed is:

1. An electrode manufacturing method comprising:
forming an electric field between a substrate and a screen by applying a first voltage to the substrate and applying a second voltage to the screen;
introducing coating powder into the electric field through the screen; and
manufacturing an electrode by causing the coating powder to adhere to the substrate, wherein:
the first voltage has a polarity opposite to a polarity of the second voltage;
when the coating powder passes through the screen, the coating powder comes into contact with the screen to apply a charge to the coating powder;
the coating powder flies in the electric field by an electrostatic force to reach the substrate; and
an angle between a flight direction of the coating powder and a vertically downward direction is 90 degrees to 270 degrees.

2. The electrode manufacturing method according to claim 1, wherein the flight direction of the coating powder is a vertically upward direction.

3. The electrode manufacturing method according to claim 1, wherein the first voltage has a positive polarity.

4. The electrode manufacturing method according to claim 1, wherein:
the coating powder contains composite particles;
each of the composite particles includes an active material particle and a coating;
the coating covers at least a part of a surface of the active material particle; and
the coating contains a binder.

5. The electrode manufacturing method according to claim 4, wherein the binder contains a fluororesin.

6. The electrode manufacturing method according to claim 1, wherein a relationship of a following expression (1) is satisfied:
Ed<f(pd) (1)
where
E represents an electric field strength of the electric field,
d represents a distance between the substrate and the screen,
p represents a gas pressure in the electric field, and
f(pd) represents a spark voltage obtained based on a Paschen curve and a product of the gas pressure and the distance.

7. The electrode manufacturing method according to claim 1, wherein the electrode is manufactured in a batch system.

8. An electrode comprising:
a substrate; and
an active material layer, wherein:
the substrate includes a first region and a second region;
the first region is covered with the active material layer;
the second region is exposed from the active material layer;
the second region is adjacent to the first region;
the active material layer includes a side end face;
the side end face is in contact with a boundary between the first region and the second region;
an angle between the side end face and the substrate is 45 degrees to 90 degrees;
the active material layer contains composite particles;
each of the composite particles includes an active material particle and a coating;
the coating covers at least a part of a surface of the active material particle;
the coating contains a binder;
a relationship of a following expression (2) is satisfied:
0.90≤α/β≤1.10 (2)
where
α represents a mass concentration of a specific element derived from the binder in an upper portion of the active material layer, and
β represents a mass concentration of the specific element in a lower portion of the active material layer,
the upper portion and the lower portion are segmented by dividing the active material layer into two equal parts in a thickness direction; and
the lower portion is located between the upper portion and the substrate.

9. The electrode according to claim 8, wherein the active material layer has a coating weight of 20 mg/cm² or more.

10. The electrode according to claim 8, wherein the active material layer has a thickness of 100 μm to 1000 μm.

11. The electrode according to claim 8, wherein:
the active material layer has a rectangular planar shape; and
a length of one side of the active material layer in plan view is 500 mm or more.

12. The electrode according to claim 8, wherein a density of metal foreign substances in the active material layer is 1 piece/m² or less.
